(19) United States
(12) Patent Application Publication
(10) Pub. No.: US 2015/0316811 A1
(43) Pub. Date: Nov. 5, 2015

(54) LIQUID CRYSTAL DISPLAY DEVICE

(71) Applicant: SHARP KABUSHIKI KAISHA, Osaka-shi, Osaka (JP)

(72) Inventors: Shinichi Uematsu, Osaka-shi (JP); Mamoru Yahata, Osaka-shi (JP)

(73) Assignee: SHARP KABUSHIKI KAISHA, Osaka-shi, Osaka (JP)

(21) Appl. No.: 14/434,795

(22) PCT Filed: Oct. 25, 2013
(86) PCT No.: PCT/JP2013/078913

§ 371 Date: Apr. 10, 2015

(30) Foreign Application Priority Data
Oct. 29, 2012 (JP) 2012-237469
Mar. 26, 2013 (JP) 2013-063518

(51) Int. Cl. G02F 1/1333; G02F 1/1335

(52) U.S. Cl. CPC G02F 1/133308; G02F 1/133524; G02F 1/1336; G02F 2001/133317; G02F 2001/133628

(57) ABSTRACT

The present invention prevents heat from flowing into an optical sheet or the like and minimizes positional displacement of an optical sheet when placed in an upright laying. A liquid crystal display device is provided with an optical sheet and a resin-made chassis that forms an air layer between the optical sheet and a light guide plate. The resin-made chassis has formed thereon a plurality of ribs that engage with a plurality of holes in the optical sheet. The plurality of holes includes a first hole that is formed in the center of the upper long side of the optical sheet, a second hole that is formed in the center of the lower long side of the optical sheet, and a third hole that is formed along both of the short sides of the optical sheet. The first hole is immovable in directions that are parallel and perpendicular to the long side of the optical sheet when engaged with the rib, the second hole is immovable in a direction that is parallel to the long side when engaged with the rib, and the third hole is movable in directions that are parallel and perpendicular to the short side when engaged with the rib.

### TECHNICAL FIELD

The present invention relates to a liquid crystal display device, and more specifically relates to a liquid crystal display device having a holding structure of an optical sheet which is adaptive to both of a lateral laying type and an upright laying type.

### BACKGROUND OF THE INVENTION

These days, a screen size of a liquid crystal display device such as a thin type television is becoming larger, and products having a screen size of, for example, a 60-inch type, a 70-inch type and an 80-inch type are sold. In such a liquid crystal display device, one which uses an LED (Light Emitting Diode) as a backlight light source instead of a conventional fluorescent tube is most commonly used. Moreover, the liquid crystal display device is used not only for a television but in various applications such as a monitor of a PC (personal computer) and a digital signage (electronic sign), and the LED is also required to have higher luminance (higher output power) accordingly.

In the above liquid crystal display device, measures for heat dissipation of the LED need to be implemented because an amount of heat generation also increases as the LED has higher luminance. For example, a structure is known that an LED substrate in which an LED serving as a heat source is arranged is attached to an aluminum heat dissipation member called heat sink (also referred to as heat spreader) to dissipate heat of the LED. Such a conventional heat dissipation structure using the heat spreader will be described based on FIG. 8 below.

FIG. 9 is a view showing a cross section of an upper end part of a liquid crystal display device having a conventional heat dissipation structure, and 100 denotes the liquid crystal display device in the figure. The liquid crystal display device 100 is provided with an ornamental member 101, a front-face frame 102, a liquid crystal panel 103, an optical sheet 104, a light guide plate 105, a reflection sheet 106, a back-face chassis (also referred to as backlight chassis) 107, a heat spreader 108 and an LED substrate 109. The front-face frame 102 is, for example, made of aluminum alloy, is arranged around the liquid crystal panel 103 with a spacer member S11 held, and functions as a front-face cabinet of the liquid crystal display device 100. Moreover, the ornamental member 101 is attached on a top face of the front-face frame 102.

On a back face side of the liquid crystal panel 103, the optical sheet 104, the light guide plate 105 and the reflection sheet 106 are provided in this order. The optical sheet 104 has functions of making light emitted from the light guide plate 105 uniform, improving luminance in a front side direction, etc. The light guide plate 105 is composed of a transparent resin such as acrylic, and emits light incident from a backlight light source to the liquid crystal panel 103. The reflection sheet 106 has functions of reflecting light which is not incident on the light guide plate 105 among the light emitted from the backlight light source to make it incident on the light guide plate 105, etc.

The LED substrate 109 is a substrate in which an LED serving as the backlight light source is arranged and is fixed to the heat spreader 108 with double-stick tape or the like. The heat spreader 108 is made of, for example, aluminum alloy whose cross section has a T-shape, and fixes the LED substrate 109 having the LED arranged therein at a position opposing to incidence surfaces formed in upper and lower ends of the light guide plate 105. Further, the backlight chassis 107 is provided on a back face side of the heat spreader 108. The backlight chassis 107 is made of, for example, iron, and has a function of dissipating heat from the heat spreader 108 to the back face side.

Moreover, the backlight chassis 107 is convex in a direction of the liquid crystal panel 103, and the liquid crystal panel 103, the optical sheet 104, the light guide plate 105 and the reflection sheet 106 are sandwiched between the backlight chassis 107 and the front-face frame 102, and each of these members is fixed in a close contact state. Specifically, as shown in FIG. 9, the backlight chassis 107 is fixed to the front-face frame 102 by a screw 110 with the heat spreader 108 and a spacer member S12 held.

In the meantime, the liquid crystal display device as described above is generally a lateral laying type in which a liquid crystal panel is arranged so that long sides of a rectangular-shaped display screen face in a horizontal direction, however, with recent diversification of uses, in a digital signage and the like, an upright laying type in which a liquid crystal panel is arranged so that short sides of a rectangular-shaped display screen face in a horizontal direction also becomes available in the market. Such a lateral laying type and an upright laying type have different holding structures of an optical sheet, so that the optical sheet needs to be prepared in accordance with respective specifications.

On the other hand, for example, Patent Literature 1 describes a liquid crystal display device using an optical sheet of a suspension support type which is adaptive to both of the lateral laying type and the upright laying type. According to this, a plurality of holes are formed on an upper part at a long side of the optical sheet as well as a plurality of holes are also formed on a left side part at a short side. In the case of the lateral laying, the plurality of holes on the upper part at the long side are engaged with a plurality of pins provided in a backlight chassis, while in the case of the upright laying, the plurality of holes on the left side part at the short side are engaged with the plurality of pins provided in the backlight chassis, so as to be adaptive both of the lateral laying type and the upright laying type.

### PRIOR ART DOCUMENT

### Patent Document

Patent Document 1: Japanese Laid-Open Patent Publication No. 2009-139572

### SUMMARY OF THE INVENTION

### Problem to be Solved by the Invention

As explained in FIG. 9 described above, due to recent designing which emphasizes the design, a model in which the front-face frame 102 is formed not by a resin but by a metal such as aluminum increases. Therefore, there is a problem that heat generated at the LED is transferred to the front-face frame 102 and the front-face frame 102 is heated up. Specifically, since the front-face frame 102 is in contact with the heat spreader 108 at a contact point C, the heat generated at the LED substrate 109 is transferred from the heat spreader 108 to the front-face frame 102 via the contact point C, and further transferred from the front-face frame 102 to the light guide plate 105 via a first suppression projection 102a. A path in which the heat is transferred at this time is shown by dotted lines of FIG. 9.

Then, a lens sheet, a luminance improved film and the like which constitute the optical sheet 104 have thin sheet shapes and are susceptible to the heat. That is, since the optical sheet 104 is in close contact with the light guide plate 105, the heat is transferred from the light guide plate 105 and there is a possibility that the sheet is thermally deformed. Such thermal deformation of the optical sheet 104 causes reduction in display quality of the liquid crystal display device, which is not desirable.

In order to prevent the thermal deformation of the optical sheet described above, it is effective to insert a resin-made chassis between a peripheral part of the optical sheet and a peripheral part of the light guide plate to thereby form an air layer between the optical sheet and the light guide plate. In this case, however, since the optical sheet and the light guide plate are separated, the optical sheet is not able to be fixed in close contact between the liquid crystal panel and the light guide plate like a conventional manner. Thus, it is considered that the optical sheet is fixed by being engaged with the resin-made chassis, but in the conventional lateral laying type, since positioning of the optical sheet is carried out at a side part, that is, at the short side, when this is made in the upright laying type as it is, there is a problem that positional displacement is likely to occur, in particular, at the long side of the optical sheet.

Note that, a technology described in Patent Literature 1 is for a structure in which the optical sheet common in the lateral laying and the upright laying is supported in a suspended manner by the backlight chassis in the liquid crystal display device by a direct-type backlight, which is not provided with a light guide plate, and does not target the liquid crystal display device by an edge light, which is provided with the light guide plate as described above.

The present invention has been made in view of circumstances as described above, and aims to provide a liquid crystal display device capable of suppressing positional displacement of an optical sheet in the case of upright laying while preventing heat from flowing into the optical sheet or the like.

### Means for Solving the Problem

To solve the above problems, a first technical means of the present invention is a liquid crystal display device, comprising: a rectangular-shaped optical sheet that is arranged on a back face side of a liquid crystal panel, a light guide plate that is provided on a back face side of the optical sheet and emits light from a light source to the liquid crystal panel, and a back-face chassis that is provided on a back face side of the light guide plate, wherein a resin-made chassis that is inserted between a peripheral part of the optical sheet and a peripheral part of the light guide plate and forms an air layer between the optical sheet and the light guide plate is included, a plurality of ribs for engaging with a plurality of holes formed in the peripheral part of the optical sheet are formed in the resin-made chassis, the plurality of holes include a first hole that is formed in a center of one long side of the optical sheet, a second hole that is formed in a center of the other long side of the optical sheet and third holes that are formed along both short sides of the optical sheet, the first hole is restricted to be immovable in directions that are parallel and perpendicular to the long sides of the optical sheet when being engaged with the rib, the second hole is restricted to be immovable in the direction that is parallel to the long sides of the optical sheet when being engaged with the rib, and the third holes are movable in directions that are parallel and perpendicular to the short sides of the optical sheet when being engaged with the ribs.

A second technical means is the liquid crystal display device of the first technical means, wherein the plurality of ribs are projected to have rectangular-shaped cross sections and the plurality of holes are formed in rectangular shapes that allow engagement with the plurality of ribs.

A third technical means is the liquid crystal display device of the first or the second technical means, wherein the first hole, the second hole and the third holes are formed in tabs that extend from the optical sheet.

A fourth technical means is the liquid crystal display device of any one of the first to the third technical means, wherein a fourth hole is formed in the one long side of the optical sheet other than the first hole, and the fourth hole is restricted to be immovable in the direction that is perpendicular to the long sides of the optical sheet when being engaged with the rib.

A fifth technical means is the liquid crystal display device of the third technical means, wherein the tab includes a bent portion that is bent to a side of the light guide plate, a fifth hole is formed in the bent portion, a different rib is formed in a direction that is orthogonal to the rib in the resin-made chassis, and the fifth hole is allowed to be engaged with the different rib.

### Effect of the Invention

According to the present invention, since provided is a structure that an air layer is formed by inserting a resin-made chassis between an optical sheet and a light guide plate, and further a plurality of holes that are formed along a peripheral part of the optical sheet are engaged with a plurality of ribs of the resin-made chassis, it is possible to suppress positional displacement of the optical sheet even in the case of upright laying while preventing heat from flowing into the optical sheet or the like.

### BRIEF DESCRIPTION OF DRAWINGS

FIG. 1 is a view showing one example of an appearance of a liquid crystal display device according to the present invention.

FIG. 2 is a view showing a state where a back-face cabinet is detached from the liquid crystal display device shown in FIG. 1.

FIG. 3 is a view showing one example of a state of an exploded internal structure of the liquid crystal display device shown in FIG. 1.

FIG. 4 is a front view of an optical sheet.

FIG. 5 is a view showing one example of a method for attaching the optical sheet of FIG. 4 to a resin-made chassis.

FIG. 6 is an enlarged view of a main part in the attachment state of FIG. 5(B).

FIG. 7 is a view showing one example of a cross section of a center part of the liquid crystal display device in which the optical sheet and the resin-made chassis are embedded.

FIG. 8 is a view for explaining another embodiment of the liquid crystal display device according to the present invention.

FIG. 9 is a view showing a cross section of an upper end part of a liquid crystal display device having a conventional heat dissipation structure.

### PREFERRED EMBODIMENT OF THE INVENTION

Description will hereinafter be given for preferred embodiments according to a liquid crystal display device of the present invention with reference to the accompanying drawings.

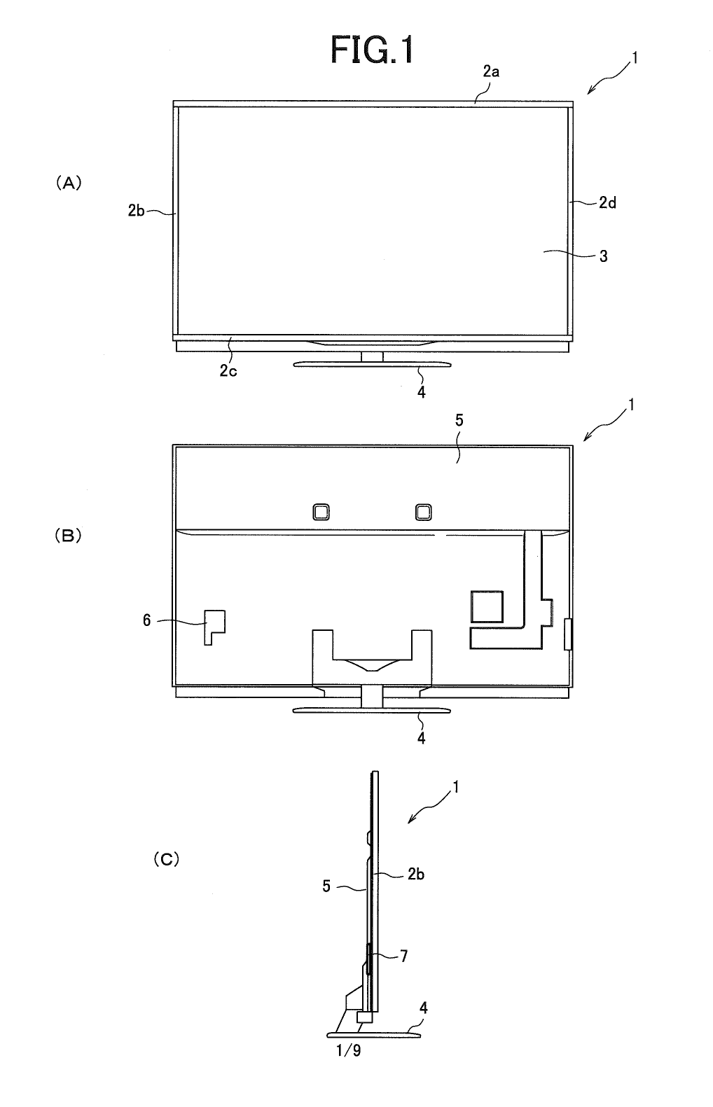

FIG. 1 is a view showing one example of an appearance of the liquid crystal display device according to the present invention. FIG. 1(A) shows a state of the liquid crystal display device viewed from the front, FIG. 1(B) shows a state of the liquid crystal display device viewed from the back, and FIG. 1(C) shows a state of the liquid crystal display device viewed from the left side. In the figures, 1 denotes the liquid crystal display device, 2a to 2d denote front-face frames (front-face cabinets), 3 denotes a liquid crystal panel, 4 denotes a stand (support pedestal), 5 denotes a back-face cabinet, 6 denotes a power cord pulling out portion, and 7 denotes an operation button portion.

In FIG. 1, the liquid crystal panel 3 has a configuration in which a liquid crystal is sandwiched between two glass substrates, and has functions as a light shutter that controls transmittance/block of light emitted from a light guide plate (not shown) when an alignment state of liquid crystal molecules constituting the liquid crystal is controlled. Moreover, the front-face frames 2a to 2d are provided around the liquid crystal panel 3 and have a frame structure in which the front-face cabinet is vertically and horizontally divided into four for saving costs of producing a mold of the front-face cabinet. The front-face frames 2a to 2d are made of not a resin but metal, for example, such as aluminum alloy for enhancing the design.

In the resin-made back-face cabinet 5, the stand 4 that supports the liquid crystal display device 1 is attached and the power cord pulling out portion 6 for pulling out a power cord from an inside of the liquid crystal display device 1 is formed. Moreover, the operation button portion 7 for operating the liquid crystal display device 1 is provided on a left-side face of the liquid crystal display device 1.

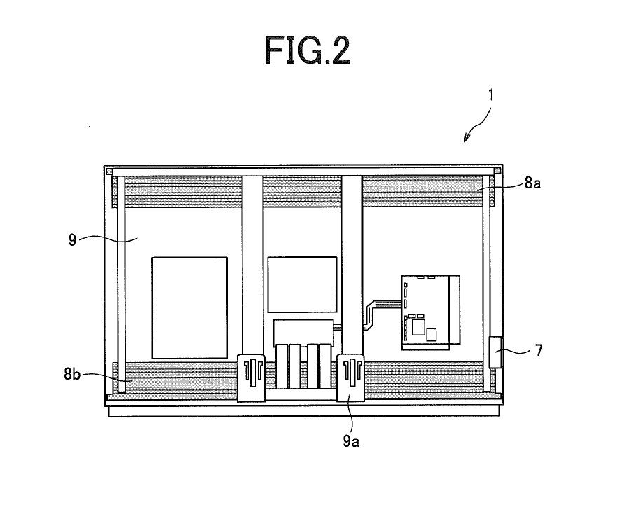

FIG. 2 is a view showing a state where the back-face cabinet 5 is detached from the liquid crystal display device 1 shown in FIG. 1. In the state where the back-face cabinet 5 is detached, heat spreaders 8a and 8b, a back-face chassis (hereinafter referred to as backlight chassis) 9, and a center seal and auxiliary metal fitting framework 9a are seen. The heat spreaders 8a and 8b function as heat dissipation members for dissipating heat generated from an LED light source, and are made of, for example, aluminum alloy having high heat dissipation performance. Further, the backlight chassis 9 is formed by metal, for example, such as iron, and the heat spreaders 8a and 8b are fixed to upper and lower ends of a back face of the backlight chassis 9. The center seal and auxiliary metal fitting framework 9a is fixed to the back face side of the backlight chassis 9 and the heat spreaders 8a and 8b.

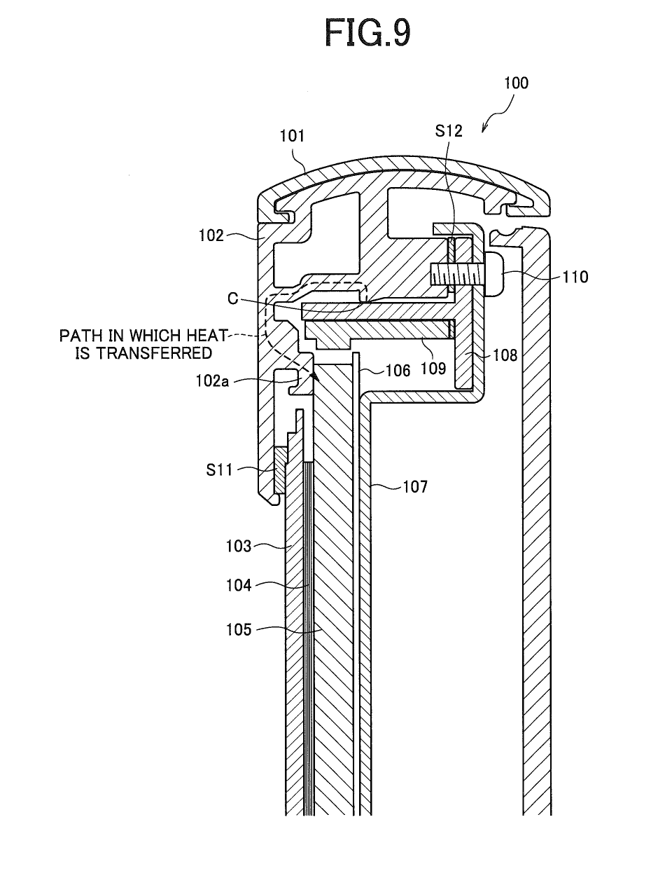

A vertical length of the heat spreaders 8a and 8b is about 150 mm, for example, when a screen size is 70 inches and material of the heat spreaders 8a and 8b is aluminum. This length is able to be determined appropriately by calculating an area needed for heat dissipation with respect to a heat generation amount of an LED according to the screen size. Further, since the heat spreaders 8a and 8b are arranged on the back face of the backlight chassis 9, it is possible to increase the heat dissipation area compared to a conventional one (FIG. 9). This makes it possible to obtain higher heat dissipation effect.

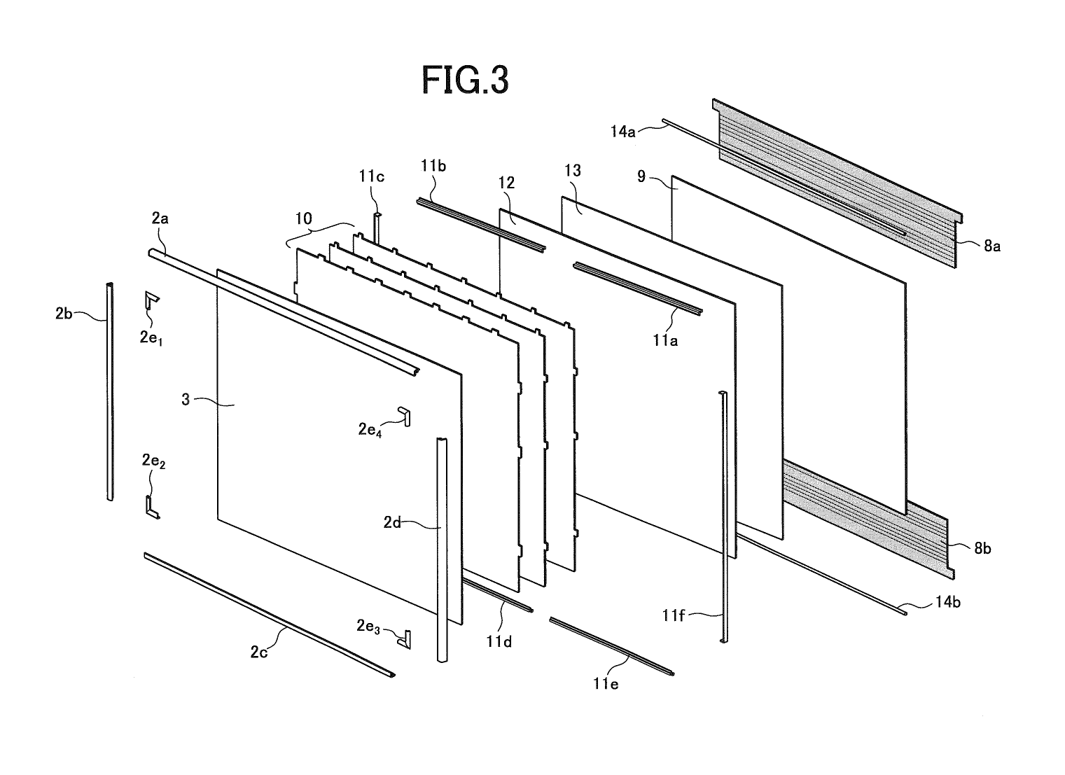

FIG. 3 is a view showing one example of a state of an exploded internal structure of the liquid crystal display device 1 shown in FIG. 1. The liquid crystal display device 1 is provided with the metallic front-face frames 2a to 2d as the front-face cabinets. These four front-face frames 2a to 2d are assembled as one frame member by four frame fastening metal fittings 2e1 to 2e4 and fixed around the liquid crystal panel 3.

On a back face side of the liquid crystal panel 3, an optical sheet 10, a light guide plate 12, and a reflection sheet are provided in this order. The optical sheet 10 is configured by, for example, two micro lens sheets and one luminance improved sheet, and has functions of making light emitted from the light guide plate 12 uniform, improving luminance in a front side direction, etc. The light guide plate 12 is formed by a transparent resin such as acrylic, and emits light from a light source to the liquid crystal panel 3. The reflection sheet 13 has functions of reflecting light which is not incident on the light guide plate 12 among the light emitted from the light source to make it incident on the light guide plate 12, etc.

The backlight chassis 9 is provided on a back face side of the light guide plate 12 and the reflection sheet 13 and holds the light guide plate 12 and the reflection sheet 13. The heat spreaders 8a and 8b are provided outside the backlight chassis 9, holds LED substrates 14a and 14b having an LED light source arranged therein at a position opposing to incidence surfaces which are formed on upper and lower ends of the light guide plate 12, and dissipates heat generated from the LED substrates 14a and 14b. Note that, the heat spreaders 8a and 8b are fixed to the LED substrates 14a and 14b with double-stick tape or the like.

Moreover, the liquid crystal display device 1 is provided with resin-made chassis 11a to 11f that are formed by plastic or the like. In this example, the resin-made chassis is divided into six, but may be divided into, for example, four, and the number of the division is not particularly limited. These resin-made chassis 11a to 11f are inserted between a peripheral part of the optical sheet 10 and a peripheral part of the light guide plate 12.

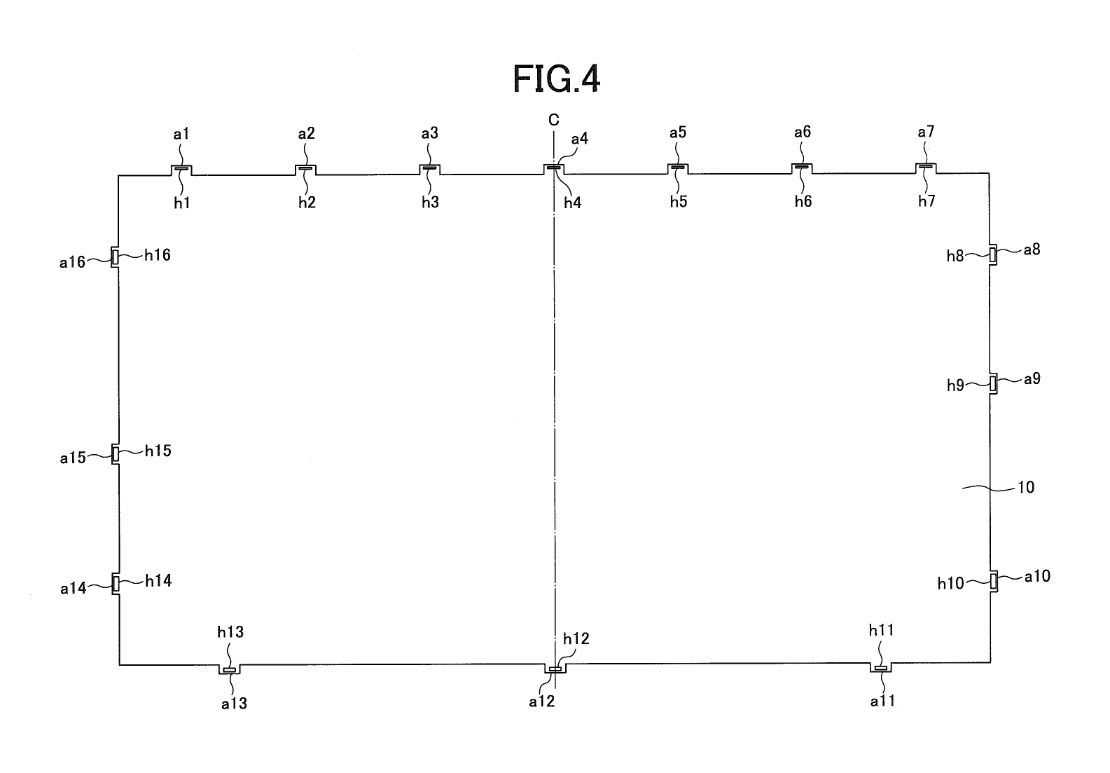

FIG. 4 is a front view of the optical sheet 10, and a1 to a16 denote tabs, h1 to h16 denote holes, and c denotes a sheet center position in the figure. Note that, in this example, three optical sheets are provided, and all the three sheets have the same configuration.

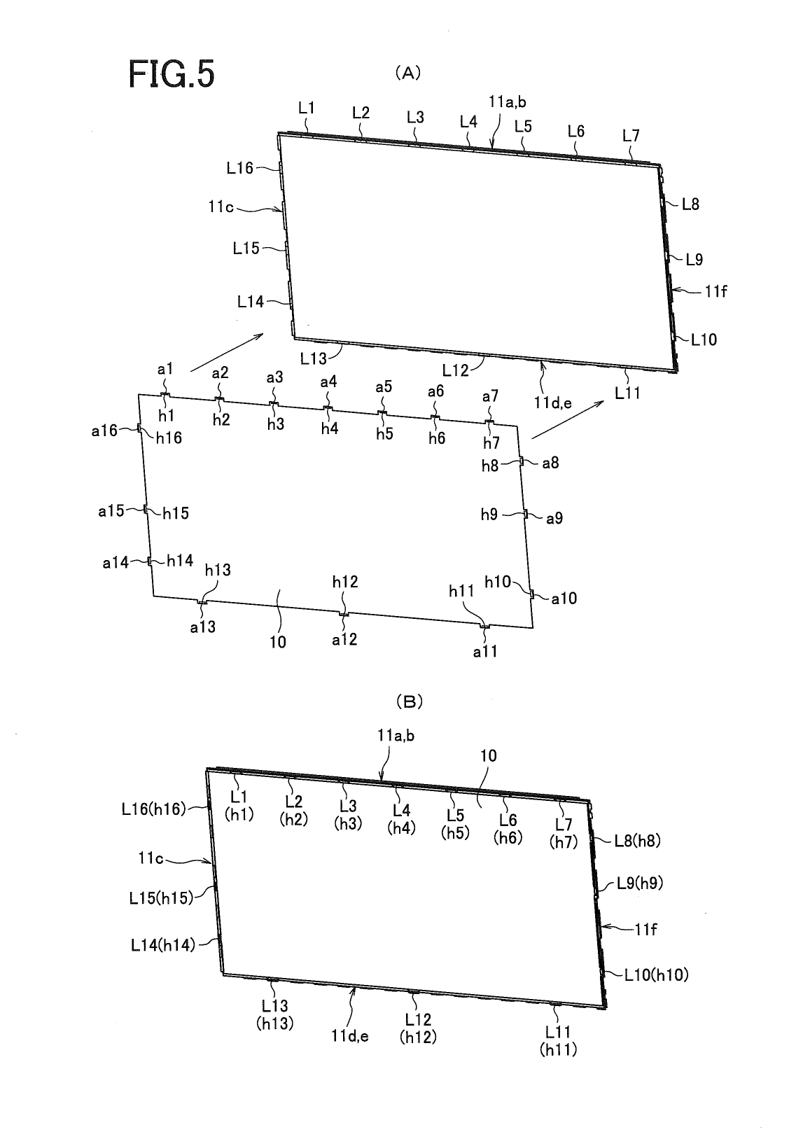

Further, FIG. 5 is a view showing one example of a method for attaching the optical sheet 10 of FIG. 4 to the resin-made chassis 11a to 11f. FIG. 5(A) shows a state before the optical sheet 10 is attached to the resin-made chassis 11a to 11f, and FIG. 5(B) shows a state where the optical sheet 10 is attached to the resin-made chassis 11a to 11f.

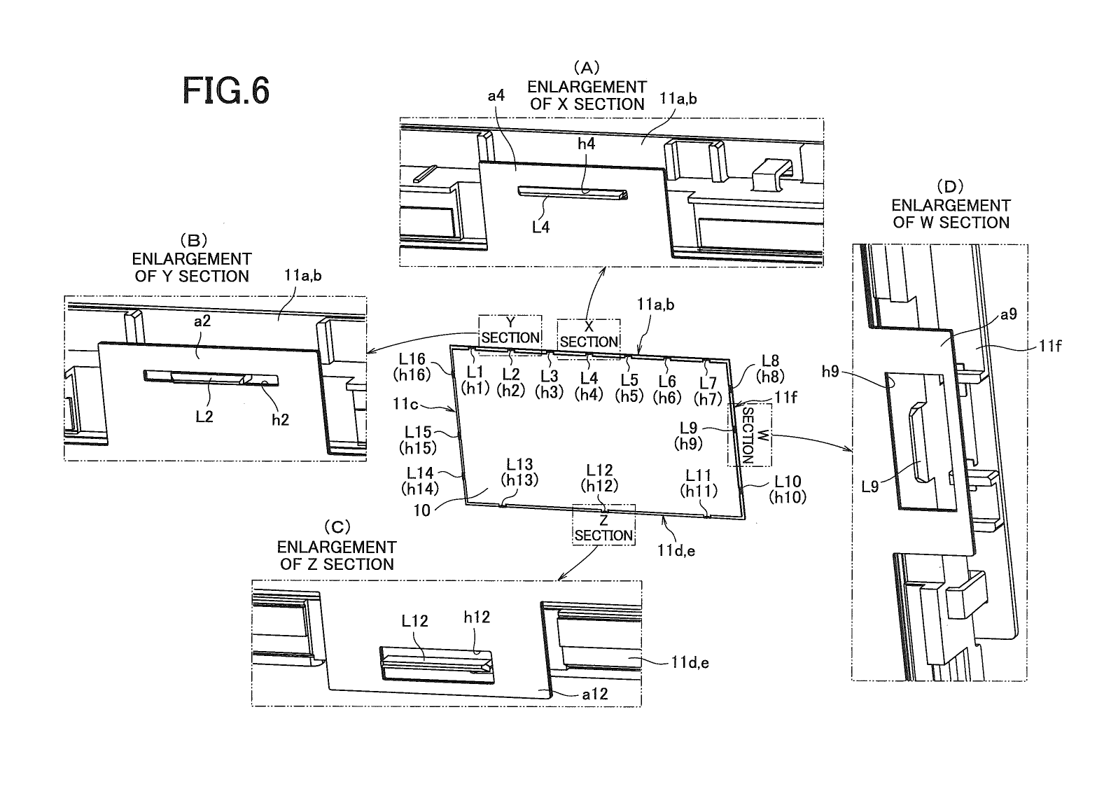

Furthermore, FIG. 6 is an enlarged view of a main part in the attachment state of FIG. 5(B).

As shown in FIG. 4 and FIG. 5, the tabs al to a16 are formed to be projected outward in the peripheral part of the optical sheet 10, and each of the holes h1 to h16 is formed in each of the tabs a1 to a16 extending from this optical sheet 10. These holes h1 to h16 are engaged with a plurality of ribs L1 to L16 that are formed in the resin-made chassis 11a to 11f.

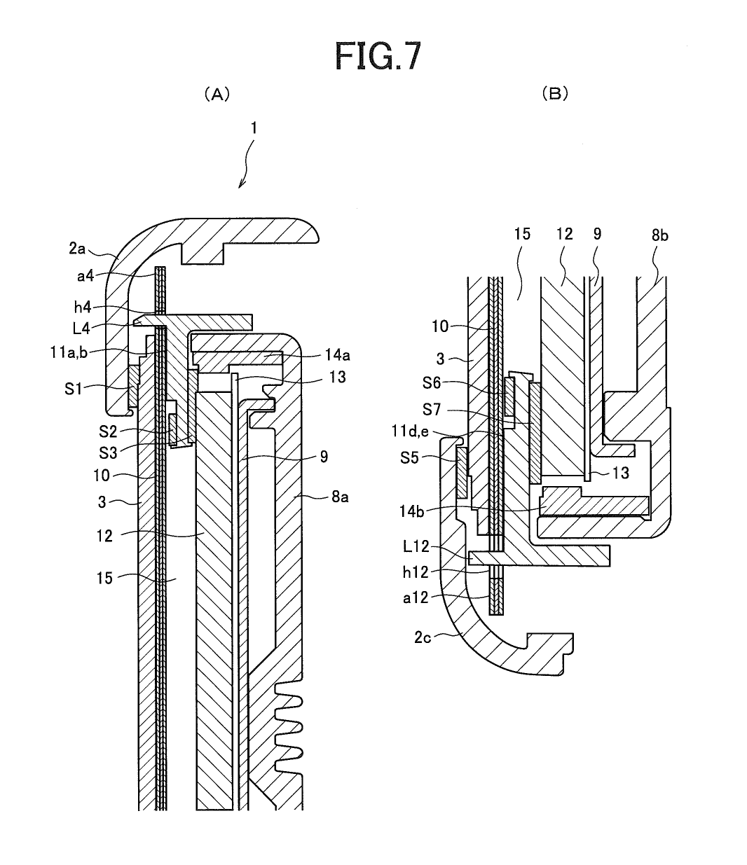

A main object of the present invention is to enable suppression of positional displacement of the optical sheet in the case of upright laying while preventing heat from flowing into the optical sheet or the like. For this configuration, the liquid crystal display device 1 is provided with the optical sheet 10 and the resin-made chassis 11a to 11f. The resin-made chassis 11a to 11f are inserted between the peripheral part of the optical sheet 10 and the peripheral part of the light guide plate 12 and form an air layer 15 (FIG. 7 described below) between the optical sheet 10 and the light guide plate 12. Moreover, the plurality of ribs L1 to L16 for engagement with the plurality of holes h1 to h16 that are formed in the peripheral part of the optical sheet 10 are formed in the resin-made chassis 11a to 11f.

In addition, the plurality of holes h1 to h16 formed in the peripheral part of the optical sheet 10 include a first hole h4 formed in a center of one long side (here, center of an upper long side) of the optical sheet 10, a second hole h12 formed in a center of the other long side (here, center of a lower long side) of the optical sheet 10, and holes h8, h9, h10, h14, h15 and h16 as one example of third holes formed along both short sides of the optical sheet 10.

Description will be given below for a case where the optical sheet 10 is arranged so as to have the long sides thereof face in a horizontal direction (in the case of lateral laying) with reference to FIG. 6. FIG. 6(A) is an enlarged view of an X section which includes vicinity of the first hole h4 and the rib L4, FIG. 6(B) is an enlarged view of a Y section which includes vicinity of the hole h2 and the rib L2, FIG. 6(C) is an enlarged view of a Z section which includes vicinity of the second hole h12 and the rib L12, and FIG. 6(D) is an enlarged view of a W section which includes vicinity of the third hole h9 and the rib L9. In this manner, the plurality of ribs L1 to L16 are projected to have rectangular-shaped cross sections, and the plurality of holes h1 to h16 are formed in rectangular shapes that allow engagement with the plurality of ribs L1 to L16.

The first hole h4 is restricted to be immovable in directions that are parallel and perpendicular to the long sides of the optical sheet 10 when being engaged with the rib L4 of the resin-made chassis 11a, b as shown in FIG. 6(A). That is, between the first hole h4 and the rib L4, there is no gap in both of the directions that are parallel and perpendicular to the long sides of the optical sheet 10, whereby the optical sheet 10 is positioned.

Further, the second hole h12 is restricted to be immovable in the direction that is parallel to the long sides of the optical sheet 10 when being engaged with the rib L12 of the resin-made chassis 11d, e as shown in FIG. 6(C). That is, between the second hole h12 and the rib L12, there is no gap in the direction that is parallel to the long sides of the optical sheet 10 and there is a gap only in the direction that is perpendicular to the long sides of the optical sheet 10. This gap makes it possible to limit the positional displacement of the optical sheet 10 to fall within an allowable range without causing unnecessary stress to be generated on the optical sheet 10 when the liquid crystal display device 1 is laid upright. That is, since both of the first hole h4 and the second hole h12 are restricted to be immovable in the direction that is parallel to the long sides of the optical sheet 10, when the liquid crystal display device 1 is laid upright, it is possible to prevent the positional displacement in the vertical direction of the optical sheet 10 and it is further possible to allow the positional displacement in the horizontal direction only by the gap between the second hole h12 and the rib L12. Note that, in the case of this example, though the rib L11 and the rib L13 are formed in the resin-made chassis 11d, e in which the rib L12 is formed, the same is also applied to engagement of the hole h11 with the rib L11 and engagement of the hole h13 with the rib L13.

Further, the third hole h9 is movable in directions that are parallel and perpendicular to the short sides of the optical sheet 10 when being engaged with the rib L9 of the resin-made chassis 11f as shown in FIG. 6(D). That is, between the third hole h9 and the rib L9, there is a gap in the both of the directions that are parallel and perpendicular to the short sides of the optical sheet 10. This gap makes it possible to limit the positional displacement of the optical sheet 10 to fall within an allowable range without causing unnecessary stress to be generated on the optical sheet 10 when the liquid crystal display device 1 is laid upright in the same manner as the above second hole h12. Note that, the same is also applied to engagement of the hole h8 with the rib L8, engagement of the hole h10 with the rib L10, engagement of the hole h14 with the rib L14, engagement of the hole h15 with the rib L15 and engagement of the hole h16 with the rib L16. Here, the third hole merely may be one each in both of the short sides of the optical sheet 10, and, for example, the holes h8, h10, h14 and h16 other than the holes h9 and h15 may not be necessary. In this case, the ribs of the resin-made chassis 11c and 11f corresponding to the short sides of the optical sheet 10 may be formed according to the third holes of the optical sheet 10.

In the above, when the third holes formed in both of the short sides of the optical sheet 10 are engaged with the ribs of the resin-made chassis 11c and 11f, an effect of enabling prevention of dropping of the optical sheet 10 when the liquid crystal display device 1 is laid upright may be attained. Further, by providing gaps between the third holes and the ribs, an effect of enabling absorption of a size change due to thermal deformation may be also attained even when the optical sheet 10 is thermally deformed.

In addition, a fourth hole may be formed other than the first hole h4 in the one long side of the optical sheet 10 (here, upper long side of the optical sheet 10). Specifically, the holes h1 to h3 and h5 to h7 correspond to the fourth holes. For example, the fourth hole h2 is restricted to be immovable in the direction that is perpendicular to the long sides of the optical sheet 10 when being engaged with the rib L2 of the resin-made chassis 11a, b as shown in FIG. 6(B). That is, between the fourth hole h2 and the rib L2, there is no gap in the direction that is perpendicular to the long sides of the optical sheet 10 and there is a gap only in the direction that is parallel to the long sides of the optical sheet 10. This gap makes it possible to limit the positional displacement of the optical sheet 10 to fall within an allowable range without causing unnecessary stress to be generated on the optical sheet 10 when the liquid crystal display device 1 is laid upright in the same manner as the above second hole h12 and third hole h9. Note that, in the case of this example, though the holes h1, h3 and h5 to h7 are formed other than the hole h2 as the fourth holes, the same is also applied to engagement of the hole h1 with the rib L1, engagement of the hole h3 with the rib L3, engagement of the hole h5 with the rib L5, engagement of the hole h6 with the rib L6 and engagement of the hole h7 with the rib L7.

FIG. 7 is a view showing one example of a cross section of a center part of the liquid crystal display device 1 in which the optical sheet 10 and the resin-made chassis 11a to 11f are embedded. FIG. 7(A) shows a cross section of an upper side of the liquid crystal display device 1 and FIG. 7(B) shows a cross section of a lower side of the liquid crystal display device 1. In FIG. 7(A), in the upper side of the liquid crystal display device 1, the front-face frame 2a, the liquid crystal panel 3, the optical sheet 10, the rein-made chassis 11a, b, the light guide plate 12, the reflection sheet 13, the backlight chassis 9, the heat spreader 8a and the LED substrate 14a are provided. Spacer members S1, S2 and S3 such as urethane are arranged between the front-face frame 2a and the liquid crystal panel 3, between the resin-made chassis 11a, b and the optical sheet 10, and between the resin-made chassis 11a, b and the light guide plate 12, respectively. That is, the cross section of FIG. 7(A) shows a state where the first hole h4 formed in the tab a4 of the optical sheet 10 is engaged with the rib L4 of the resin-made chassis 11a, b.

Here, though heat generated at the LED substrate 14a in which the LED serving as a heat source is arranged is dissipated by the heat spreader 8a which is a heat dissipation member, by arranging the heat spreader 8a outside the backlight chassis 9, it is possible to make it difficult for the heat to be transferred to the light guide plate 12, the optical sheet 10 and the like. Note that, it is desired that the heat spreader 8a is partially in contact with the backlight chassis 9. This makes it possible to reduce the heat transferred from the heat spreader 8a to the backlight chassis 9.

Further, as described above, by inserting the resin-made chassis 11a, b between the optical sheet 10 and the light guide plate 12, the air layer 15 is formed between the optical sheet 10 and the light guide plate 12. Then, since this air layer 15 functions as a heat insulating layer which blocks heat generation at the LED substrate 14a, it becomes possible to make it difficult for the heat to be transferred to the optical sheet 10.

In FIG. 7(B), in the lower side of the liquid crystal display device 1, the front-face frame 2c, the liquid crystal panel 3, the optical sheet 10, the resin-made chassis 11d, e, the light guide plate 12, the reflection sheet 13, the backlight chassis 9, the heat spreader 8b and the LED substrate 14b are provided. The basic configuration is same as the configuration of the upper side of FIG. 7(A), and spacer members S5, S6 and S7 such as urethane are arranged between the front-face frame 2c and the liquid crystal panel 3, between the resin-made chassis 11d, e and the optical sheet 10, and between the resin-made chassis 11d, e and the light guide plate 12, respectively. That is, the cross section of FIG. 7(B) shows a state where the second hole h12 formed in the tab a12 of the optical sheet 10 is engaged with the rib L12 of the resin-made chassis 11d, e.

Further, in the same manner as the upper side of the liquid crystal display device 1, in the lower side of the liquid crystal display device 1 as well, by inserting the resin-made chassis 11d, e between the optical sheet 10 and the light guide plate 12, the air layer 15 is formed between the optical sheet 10 and the light guide plate 12. Then, since this air layer 15 functions as a heat insulating layer which blocks heat generation at the LED substrate 14b, it becomes possible to make it difficult for the heat to be transferred to the optical sheet 10.

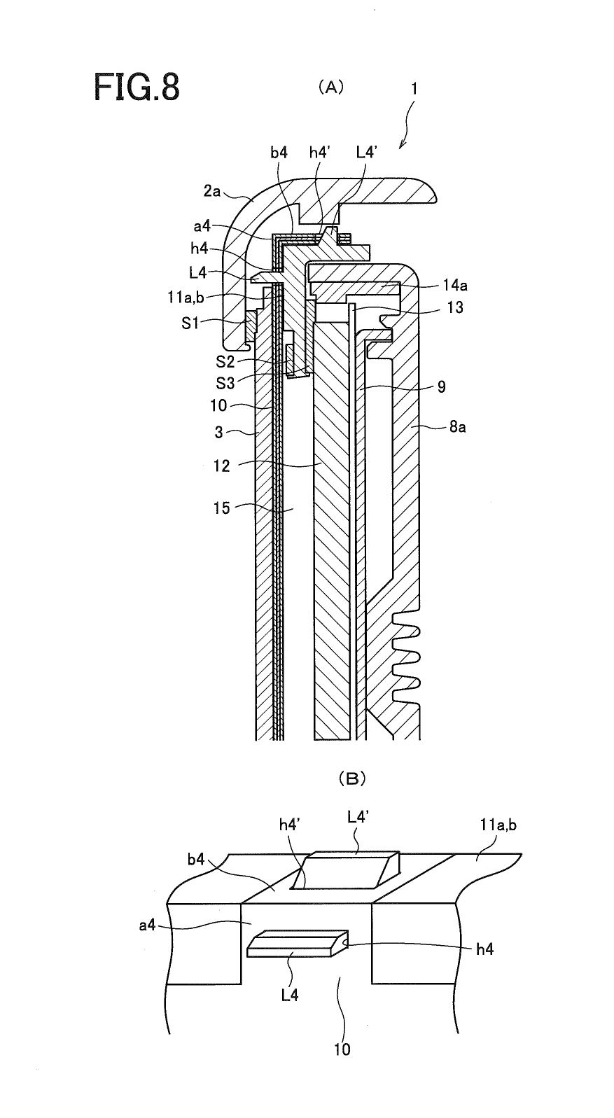

FIG. 8 is a view for explaining another embodiment of the liquid crystal display device according to the present invention. FIG. 8(A) is a view showing one example of a cross section of a center upper side of the liquid crystal display device 1. FIG. 8(B) is a view schematically showing a surrounding part of a rib. According to the configuration described so far, the positional displacement of the optical sheet 10 is restricted in vertical and horizontal directions of the liquid crystal display device 1 by the ribs L1 to L16 of the resin-made chassis 11a to 11f, but not restricted in a depth direction of the liquid crystal display device 1. Therefore, when the liquid crystal display device 1 oscillates, etc., the optical sheet 10 moves in the depth direction and is in friction with the liquid crystal panel 3, so that there is a possibility of causing a problem that the optical sheet 10 is damaged, etc.

On the other hand, as shown in FIG. 8, the tab a4 of the optical sheet 10 has a bent portion b4 which is bent to a side of the light guide plate 12, and a fifth hole h4′ is formed in this bent portion b4. Moreover, the resin-made chassis 11a, b may have a different rib L4′ in a direction orthogonal to the rib L4 and the fifth hole h4′ maybe engaged with the different rib L4′. Thereby, the optical sheet 10 is restricted to be immovable in the depth direction of the liquid crystal display device 1, thus making it possible to prevent the optical sheet 10 from being damaged by being in friction with the liquid crystal panel 3. Further, since the tab a4 of the optical sheet 10 is bent, a frame part of the front-face frame 2a is able to be made smaller accordingly and it is possible to try to achieve a so-called narrower frame.

Note that, though description has been given with the tab a4 as a representative example in this example, the fifth holes may be formed in all of the tabs a1 to a16 of the optical sheet 10, and the fifth holes may be formed partially, for example, such as alternately or a plurality of pieces apart among the tabs a1 to a16. In both cases, different ribs corresponding to the fifth holes on the tab side are provided in the resin-made chassis 11a to 11f in directions orthogonal to the ribs L1 to L16. This allows the fifth holes of the optical sheet 10 to be engaged with the different ribs of the resin-made chassis 11a to 11f and the optical sheet 10 is restricted to be immovable in the depth direction.

As described above, the liquid crystal display device according to the present invention is a liquid crystal display device comprising a rectangular-shaped optical sheet that is arranged on a back face side of a liquid crystal panel, a light guide plate that is provided on a back face side of the optical sheet and emits light from a light source to the liquid crystal panel, and a back-face chassis that is provided on a back face side of the light guide plate, in which a resin-made chassis that is inserted between a peripheral part of the optical sheet and a peripheral part of the light guide plate and forms an air layer between the optical sheet and the light guide plate is included, a plurality of ribs for engagement with a plurality of holes formed in the peripheral part of the optical sheet are formed in the resin-made chassis, the plurality of holes include a first hole that is formed in a center of one long side of the optical sheet, a second hole that is formed in a center of the other long side of the optical sheet and third holes that are formed along both short sides of the optical sheet, the first hole is restricted to be immovable in directions that are parallel and perpendicular to the long sides of the optical sheet when being engaged with the rib, the second hole is restricted to be immovable in the direction that is parallel to the long sides of the optical sheet when being engaged with the rib, and the third holes are movable in directions that are parallel and perpendicular to the short sides of the optical sheet when being engaged with the ribs. This makes it possible to limit the positional displacement of the optical sheet to fall within an allowable range without causing unnecessary stress to be generated on the optical sheet when the liquid crystal display device is laid upright, while preventing heat from flowing into the optical sheet.

Moreover, it is desired that the plurality of ribs are projected to have rectangular-shaped cross sections and the plurality of holes are formed in rectangular shapes that allow engagement with the plurality of ribs. This makes it possible, with a simple structure, to limit the positional displacement of the optical sheet to fall within an allowable range without causing unnecessary stress to be generated on the optical sheet when the liquid crystal display device is laid upright.

Moreover, it is desired that the first hole, the second hole and the third holes are formed in tabs that extend from the optical sheet. This makes it possible, with a simple structure, to limit the positional displacement of the optical sheet to fall within an allowable range without causing unnecessary stress to be generated on the optical sheet when the liquid crystal display device is laid upright.

Moreover, it is desired that a fourth hole is formed in the one long side of the optical sheet other than the first hole, and the fourth hole is restricted to be immovable in the direction that is perpendicular to the long sides of the optical sheet when being engaged with the rib. This makes it possible to limit the positional displacement of the optical sheet to fall within an allowable range more effectively without causing unnecessary stress to be generated on the optical sheet when the liquid crystal display device is laid upright.

Moreover, it is desired that the tab includes a bent portion that is bent to aside of the light guide plate, a fifth hole is formed in the bent portion, another rib is formed in a direction that is orthogonal to the rib in the resin-made chassis, and the fifth hole is allowed to be engaged with the different rib. Thereby, the optical sheet is restricted to be immovable in a depth direction of the liquid crystal display device, thus making it possible to prevent the optical sheet from being damaged by being in friction with the liquid crystal panel.

### EXPLANATIONS OF LETTERS OR NUMERALS

1 . . . liquid crystal display device, 2a to 2d . . . front-face frame, 2e1 to 2e4 . . . frame fastening metal fitting, 3 . . . liquid crystal panel, 4 . . . stand, 5 . . . back-face cabinet, 6 . . . power cord pulling out portion, 7 . . . operation button portion, 8a, 8b . . . heat spreader, 9 . . . back-face chassis (backlight chassis), 9a . . . center seal and auxiliary metal fitting framework, 10 . . . optical sheet, 11a to 11f . . . resin-made chassis, 12 . . . light guide plate, 13 . . . reflection sheet, 14a, 14b . . . LED substrate, and 15 . . . air layer.

1. A liquid crystal display device, comprising: a rectangular-shaped optical sheet that is arranged on a back face side of a liquid crystal panel, a light guide plate that is provided on a back face side of the optical sheet and emits light from a light source to the liquid crystal panel, and a back-face chassis that is provided on a back face side of the light guide plate, wherein
a resin-made chassis that is inserted between a peripheral part of the optical sheet and a peripheral part of the light guide plate and forms an air layer between the optical sheet and the light guide plate is included,
a plurality of ribs for engaging with a plurality of holes formed in the peripheral part of the optical sheet are formed in the resin-made chassis,
the plurality of holes include a first hole that is formed in a center of one long side of the optical sheet, a second hole that is formed in a center of the other long side of the optical sheet and third holes that are formed along both short sides of the optical sheet,
the first hole is restricted to be immovable in directions that are parallel and perpendicular to the long sides of the optical sheet when being engaged with the rib, the second hole is restricted to be immovable in the direction that is parallel to the long sides of the optical sheet when being engaged with the rib, and the third holes are movable in directions that are parallel and perpendicular to the short sides of the optical sheet when being engaged with the ribs.

2. The liquid crystal display device according to claim 1, wherein
the plurality of ribs are projected to have rectangular-shaped cross sections and the plurality of holes are formed in rectangular shapes that allow engagement with the plurality of ribs.

3. The liquid crystal display device according to claim 1, wherein
the first hole, the second hole and the third holes are formed in tabs that extend from the optical sheet.

4. The liquid crystal display device according to claim 1, wherein
a fourth hole is formed in the one long side of the optical sheet other than the first hole, and the fourth hole is restricted to be immovable in the direction that is perpendicular to the long sides of the optical sheet when being engaged with the rib.

5. The liquid crystal display device according to claim 3, wherein
the tab includes a bent portion that is bent to a side of the light guide plate, a fifth hole is formed in the bent portion, a different rib is formed in a direction that is orthogonal to the rib in the resin-made chassis, and the fifth hole is allowed to be engaged with the different rib.
